(19) United States
(12) Patent Application Publication
(10) Pub. No.: US 2022/0019687 A1
(43) Pub. Date: Jan. 20, 2022

(54) SYSTEMS FOR AND METHODS OF DATA OBFUSCATION

(71) Applicant: Phennecs, LLC, Orange, TX (US)

(72) Inventor: Blake Matthew Poutra, Orange, TX (US)

(21) Appl. No.: 16/902,236

(22) Filed: Jun. 15, 2020

Related U.S. Application Data
(60) Provisional application No. 62/861,128, filed on Jun. 13, 2019.

(51) Int. Cl. G06F 21/62; G06F 40/205; G06F 40/151

(52) U.S. Cl. CPC G06F 21/6245; G06F 40/151; G06F 40/205

(57) ABSTRACT

Systems for and methods of data obfuscation. Embodiments provide data obfuscation at the field level across all tables in a database based on the fields that are configured and mapped to the type of desired obfuscation. There are several obfuscation options, including anonymization, pseudonymization, and combinations thereof. In each case, it is possible that the processes can be reversible or irreversible.

### RELATED APPLICATION

This application claims the benefit of U.S. Provisional Application No. 62/861,128, filed on Jun. 13, 2019. The application referred to in this paragraph is incorporated by reference as if set forth fully herein.

### BACKGROUND OF THE INVENTION

### Field of the Invention

The disclosure herein relates to systems for and methods of obfuscating sensitive data and, more particularly, to obfuscating private personal data in a development and/or archival environment.

### Description of the Related Art

Personally Identifying Information (PII), Personal Information (PI), and Sensitive Personal Information (SPI), often referred to collectively herein as “sensitive data,” are data items that are valuable to both the individuals to which they belong and to the enterprises charged with their safekeeping. Preserving the privacy of sensitive data is vitally important to most organizations; however, this mandate can also be at odds with other directives of a company, including, for example:
Adding value to customers through the synthesis and mining of their data (e.g., recommendations, customer service);
Adding value to customers through the synthesis and intermingling of their data with others (e.g., cohort analysis); and
Adding value to customers through the enhancement of new products.

In order to achieve these objectives, handling and usage of sensitive data is a part of normal business practice. Allowing sensitive data from production applications to be copied and used in archival, development, and testing environments (e.g., a sandbox) increases the potential for theft, loss or exposure, significantly increasing the company's risk. Data obfuscation (or masking) is emerging as a best practice for hiding real data so it can be safely used in non-production environments. This helps organizations meet compliance requirements for Payment Card Industry (PCI), Health Insurance Portability and Accountability Act (HIPAA), Gramm-Leach-Biley Act (GLBA) and other data privacy regulations.

Data obfuscation is the process of de-identifying (obfuscating or transforming) specific elements within data stores by applying one-way (i.e., irreversible) algorithms to the data. The process ensures that sensitive data is replaced with useful dummy data, for example, scrambling the digits in a telephone number while preserving the data format. The irreversible nature of the algorithm means there is no need to maintain keys to restore the data as one would with encryption or tokenization where the original data may be recovered.

The drive for data masking is largely due to regulatory compliance requirements that mandate the protection of PI, PII, and other sensitive information. As previously mentioned, U.S. regulations such as HIPAA and GLBA require careful treatment of personal data. The trend extends globally. For example, in 2018 the European Union implemented the General Data Protection Regulation (GDPR) which regulates handling and usage of personal data. Several U.S. states have passed, or are in the process of passing, data privacy laws closely modeled after the GDPR, such as the California Consumer Privacy Act (CCPA) which passed in 2018.

Many companies are rightfully concerned about risk management in the development and archival environments. A lack of processes and technology to protect data in non-production environments can leave the company open to data theft or exposure and regulatory non-compliance. Data obfuscation is an effective way to mitigate enterprise risk. Development and test environments are rarely as secure as production, and in most cases, developers should not need access to actual sensitive data. Indeed, there are often legal or ethical reasons why sensitive data should be visible only to a limited set of need-to-see people.

If production data is sourced for testing, many data managers use anonymization techniques, applying to all sensitive information, and this process must be irreversible. Anonymization is the process of either encrypting or removing sensitive information from data sets, so that the people described by that data remain anonymous.

In some cases, anonymization may be sufficient. In other cases, development requires, or at least would greatly benefit from, data that is contextually useful. For example, if an anonymization algorithm converts a name like “John Smith” into an anonymized character string like “Neff Taapz.” To be sure, the data has been anonymized, but in so doing it has also been stripped of useful context. That is, in the development and testing environments, the data may not be immediately recognizable (or recognizable at all) as a personal name. This is a major drawback of many modern anonymization techniques. One solution to this problem is the use of “pseudonymization” as an alternative. Pseudonymization is a data management and de-identification procedure by which sensitive data fields within a data record are replaced by one or more artificial identifiers, or pseudonyms. A single pseudonym for each replaced field or collection of replaced fields makes the data record less identifiable while remaining suitable for data analysis and data processing, especially in development and archival environments.

Thus, there is a need in the industry for a product that can quickly and reliably provide customizable obfuscation or transformation functions, including anonymization and pseudonymization, to large data sets that include sensitive information, especially for the purpose of securely moving production data into a development or testing environment and for archival.

### DESCRIPTION OF THE DRAWINGS

FIG. 1 is screenshot of a computer application according to an embodiment of the present disclosure.

FIG. 2 is screenshot of a computer application according to an embodiment of the present disclosure.

FIG. 3 is screenshot of a computer application according to an embodiment of the present disclosure.

FIG. 4 is screenshot of a computer application according to an embodiment of the present disclosure.

FIG. 5 is screenshot of a computer application according to an embodiment of the present disclosure.

### DETAILED DESCRIPTION OF THE DISCLOSURE

Embodiments of the invention can be implemented in numerous ways, including as a method, a process, an apparatus, a system, a composition of matter, a computer readable medium such as a computer readable storage medium or a computer network wherein program instructions are sent over optical or communication links. A component such as a processor or a memory described as being configured to perform a task includes both general components that are temporarily configured to perform the task at a given time and/or specific components that are manufactured to perform the task. In general, the order of the steps of disclosed methods or processes may be altered within the scope of the invention.

A detailed description of one or more embodiments of the invention is provided below along with accompanying figures that illustrate the principles of operation. Embodiments of the invention are described with particularity, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Various aspects will now be described in connection with exemplary embodiments, including certain aspects described in terms of sequences of actions that can be performed by elements of a computer system. For example, it will be recognized that in each of the embodiments, the various actions can be performed by specialized circuits, circuitry (e.g., discrete and/or integrated logic gates interconnected to perform a specialized function), program instructions executed by one or more processors, or by any combination. Thus, the various aspects can be embodied in many different forms, and all such forms are contemplated to be within the scope of what is described. The instructions of a computer program for obfuscating electronic data can be embodied in any computer-readable medium for use by or in connection with an instruction execution system, apparatus, or device, such as a computer based system, processor containing system, or other system that can fetch the instructions from a computer-readable medium, apparatus, or device and execute the instructions.

As used herein, a “computer-readable medium” can be any means that can contain, store, communicate, propagate, or transport a program for use by or in connection with an instruction execution system, apparatus, or device. The computer-readable medium can be, for example but is not limited to, an electronic, magnetic, optical, electromagnetic, infrared, or semiconductor system, apparatus, device, or propagation medium. More specific examples of the computer readable-medium can include the following: an electrical connection having one or more wires, a portable computer diskette or compact disc read only memory (CD-ROM), a random access memory (RAM), a read only memory (ROM), an erasable programmable read only memory (EPROM or Flash memory), and an optical fiber. Other types of computer-readable media are also contemplated.

The present disclosure includes embodiments of systems for and methods of obfuscating sensitive data in a development/testing/archival environment. Although the application may be used by any database vendor, reference is made throughout the disclosure to database services and products offered by Salesforce, Inc (“Salesforce”). Thus, exemplary embodiments of a Data Obfuscation Tool (DOT) are disclosed with reference to certain Salesforce terms. However, it is understood that other embodiments are possible on various platforms, notwithstanding the use of terms or references that are unique to the Salesforce platform. Thus, embodiments of the DOT are intended to be platform-agnostic.

For clarity, the terms “obfuscation” and “transformation” are used interchangeably herein to indicate data transformations such as anonymization, pseudonymization, and combinations of both.

In general, embodiments of the DOT provide data obfuscation at the field level across all tables in a database based on the fields that are configured and mapped to the type of desired obfuscation. There are several obfuscation options, including anonymization, pseudonymization, and combinations thereof. In each case, it is possible that the processes can be reversible or irreversible. However, most of the disclosure herein is focused on irreversible processes, meaning that, after the anonymization/pseudonymization, the original field value cannot be recovered by reverse engineering. In cases where the user wants the process to be reversible, it may be used in conjunction with encryption, for example.

### Anonymization

Embodiments of the DOT provide both reversible and irreversible anonymization. Once the fields have been identified and configured, either manually or automatically, the system can run internal batch classes with anonymization algorithms to replace the data with anonymized values. In one embodiment, these new anonymized values are irreversible in accordance with industry standard data privacy compliance regulations.

Importantly, the anonymized data is provided, for example to a sandbox, without the use of a database and without calling out to third party external systems. That is, the anonymization process is completely internalized and can be run on a single platform. This ensures that the user never loses control of the data or the process. Because, in the vast majority of instances, the user has already accepted the privacy terms and conditions as a result of signing up to the use the platform, it is not necessary for the DOT to meet any additional compliance standards prior to implementation.

Embodiments of the DOT allow for the obfuscation process to run either automatically after each refresh or on an ad hoc basis. For example, Salesforce allows a full refresh every 29 days for a full sandbox and every 5 days for a partial sandbox. In some cases, the user will want push new data to a sandbox in between refreshes. Here, the DOT can run ad hoc to anonymize the data that has been pushed to the sandbox without having to wait for a refresh.

Some platforms include classes that require significant computing to run on batches. Thus, the DOT can run anonymization/pseudonymization as a batch class across millions of records, hundreds of tables, and various data types, enabling the DOT to run on platforms that have governor limits.

### Pseudonymization

Embodiments of the DOT provide pseudonymization. Similarly, as with anonymization, once the fields are identified and configured, either manually or automatically, the system runs internal batch classes with algorithms to provide human readable pseudonymized values. This is particularly useful when development would benefit from contextual association (e.g., the pseudonymized value of a full name resembles an actual real name, albeit one that is irreversibly disassociated from the actual full name). Pseudonymization provides context that is missing from anonymized data, allowing for developers to better recognize and understand the data with which they are working.

Embodiments of the DOT provide pseudonymized values that are both reversible and irreversible. Pseudonymization may be run entirely internally on a single platform. That is, it runs without a database and without calling out to third party external systems. In some embodiments, pseudonymization is applied using a custom library populated with values that the user has chosen. Custom libraries can be either be imported or built from scratch.

Embodiments of the DOT allow users to accurately match field value semantics. For example, values in a First Name field have different characteristics than values in a Last Name field. As a part of the pseudonymization configuration, the DOT prompts the user to select a particular data field from a pick list, which will associate the data to be pseudonymized with a particular data type so that the pseudonymized data shares those common semantic characteristics with the original input data. In one embodiment, based on a set of static rules, the DOT will suggest a particular data field for the input data by, for example, displaying those “best guess” choices at the top of the pick list or otherwise highlighting them within the list. In another embodiment, the DOT uses machine learning to continually improve the data field suggestion feature. In yet another embodiment, the DOT automatically assigns a data field to the input data.

Embodiments of the DOT allow a user to select anonymization or pseudonymization across various languages. For example, pseudonymization of values within a Last Name field in a database populated primarily with information related to English-speakers will draw from a different library of last names than would pseudonymization of a Last Name field with names of Japanese-speakers. Thus, in one embodiment the DOT allows the user to select the language during pseudonymization configuration. In another embodiment, the DOT suggests a particular language. And in yet another embodiment, the language is automatically detected and assigned.

As previously noted, embodiments of the DOT allow for the combination of anonymization and pseudonymization to provide unique transformations. In one configuration the DOT transforms a record by combining a library value (pseudonymization) with a random value. For example, the record “John Smith” might be transformed to “Paul Thomas fy34n,” which includes the pseudonymized portion “Paul Thomas” plus the anonymized portion “fy34n” to form the composite transformation.

In some cases, it may be advantageous to create a composite transformation that comprises both an anonymized/pseudonymized component and an original (i.e., untransformed) component. For example, in one embodiment the DOT may transform an email record using multiple libraries according to the following formula:

FirstName (pseudonymized) “.” LastName (pseudonymized) “@emailservice.com” RecordID (untransformed).
This exemplary formula provides a composite transformation with a transformed component and an untransformed component. The untransformed component (here, RecordID) allows for reference-ability for both internal and external integrations. In this case, the untransformed component (RecordID) is a nonsensitive abstraction from the original record (i.e., the untransformed component does not contain PII).

Embodiments of the DOT can also provide transformations using pattern generation algorithms similar to those used in regular expression (“regex”) string searching algorithms. This allows the user to define a transformation comprising a set of random values that are arranged according to a particular user-defined pattern.

Embodiments of the DOT provide various features which facilitate the anonymization/pseudonymization functions, some of which are discussed in more detail herein.

Pre-Processing of Records

In one embodiment, the records may be pre-processed in order to improve the transformation. First, all the records within a table are mapped so that their location within the database is known. Then the records can be sorted based on a unique identifier or index. Once the records have been sorted, they can be parsed into batches of a predetermined size, and the transformation can be done on a batch basis which prevents, for example, time-out errors that may occur when too many records are requested at the same time.

Pre-processing can be done on the client side (e.g., in a browser), on the server side, or both. In some cases, it may be advantageous to pre-process on the server side as it may speed up the pre-processing and is more consistent, avoiding issues such as a browser being close prematurely, an internet outage, or the like.

Automatic Feature Deactivation/Reactivation

In some embodiments, the DOT will deactivate certain features to enable or facilitate the data transformation. For example, the DOT may automatically deactivate automated features such as triggers, flows, workflows, processes, validation rules, chatter, feed tracking, field histories, look-up filters, and many others. Similarly, the DOT can automatically reactivate those same features after the transformation process is complete. These same features may also be deactivated/reactivated manually. If a user needs to cancel an execution, they have the ability to abort the execution. Once aborted, the DOT can reactivate any automations that had been deactivated during data transformation. In cases where an execution did not complete on its own, the user can manually reactivate automations that were deactivated.

Data Deletion

Some embodiments of the DOT will delete data as a form of transformation/obfuscation. Some types of data, such as long text, chatter, and email, may be deleted automatically. Delete is also an option on fields that are not flagged as “required.” In some cases, it may be advantageous to delete data while running the DOT in a production environment. This action will typically require an archive into either on- or off-platform storage before deletion occurs.

Sensitive Data Identification

In some cases, users are unsure where sensitive data exists within a database or, for convenience, would simply prefer all fields that are likely to contain sensitive data to be identified prior to anonymization/pseudonymization. Embodiments of the DOT are capable of providing suggestions as to which fields have a high probability of containing sensitive information. Various characteristics of the fields may be analyzed to provide the suggestion. For example, in one embodiment, the labels and API names of each field are analyzed and compared against a library of key words, triggering a high probability indication if certain similarity criteria are met. In another embodiment, the DOT analyzes the characteristics of actual field values to determine the likelihood that a particular field includes sensitive data. In order to build the criteria, various field value characteristics may be used including, for example: key words; metadata; number of characters; field format; and data type (e.g., integer, alphanumeric, varchar). Any combination of field characteristics may be used to trigger a sensitive data alert. For example, in one embodiment, a set of characters may be recognized as numerals and a character pattern may be recognized as three numerals followed by a dash followed by three numerals followed by a dash followed by four numerals (###-###-####). Such a combination of character type and character pattern likely identifies a U.S. phone number and, as such, would constitute sensitive data. DOT can then alert the user that the field is likely to contain sensitive data, or it can automatically mark the field for anonymization/pseudonymization. It is understood that these and many other field value characteristics may be used to establish triggering criteria. A particular criterion may be triggered by a single characteristic or by a combination of characteristics that may be weighted to provide the most accurate prediction outcome. In another embodiment, the DOT uses machine learning to identify fields that are likely to contain sensitive data.

The sensitive data identification feature can be enabled by a particular user or implemented across an entire platform. For example, the sensitive data identification feature can dynamically scan all client databases to identify likely locations of sensitive data. During the scan process, it is also possible to identify and filter non-editable fields that cannot be anonymized/pseudonymized. Those non-editable fields would not appear in the list of fields during anonymization/pseudonymization configuration or, alternatively, would appear as unavailable.

In some embodiments, the sensitive data identification feature may be used to design and articulate a data posture and then to enable the enforcement of policy that would comply with the posture.

The sensitive data identification feature may also be used to build a configuration template from a data classification model, further automating the anonymization/pseudonymization process. Such a template can be easily saved, copied, and exported.

Sensitive Data Vulnerability/Visibility Reporting

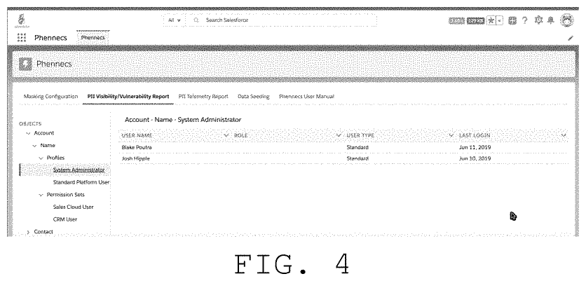

As organizations grow, so does the amount of data that they must keep and use and the number of employees and contractors that must regularly touch the data. Embodiments of the DOT provide reports to identify users (internal and external) that have access to sensitive data. This allows the company to conveniently analyze which sets of data should be tagged or prioritized for anonymization/pseudonymization and to determine which obfuscation type is most appropriate. A screenshot from an exemplary DOT application is shown in FIG. 4. In this screenshot, the user has created a sensitive data vulnerability/visibility report that indicates that two users (Blake Poutra and Josh Hipple) can see the data values for the Name field. In this embodiment, the DOT allows the user to easily specify a particular field or fields on which to run the report. Information from this report may be significant in determining which data sets to obfuscate and the type obfuscation to be used. In some embodiments, the reports may be configured and generated manually. In other embodiments, the reports may be triggered and generated automatically, for example, in conjunction with the sensitive data identification feature. In this example, the sensitive date identification feature would provide a list of fields where sensitive data is likely to exist, and then the vulnerability/visibility report would automatically run for all fields exceeding a particular probability threshold.

The DOT provides additional types of reports as well. In one embodiment, a report of the reconciliation of the anonymized/pseudonymized data compared with the requested configuration may be generated, either manually or automatically. In another embodiment, a report of the reconciliation of the anonymized/pseudonymized data compared with a data classification model may be generated, either manually or automatically.

The DOT also recognizes and responds to data in run logs (e.g., job status, specific record, errors in the transformation, and likely cause of errors). This is advantageous as capturing and processing the point at which an error is logged allows the DOT to identify and address the error in subsequent runs of the anonymization/pseudonymization process which may be started at the point error.

Obfuscation Telemetry Reporting

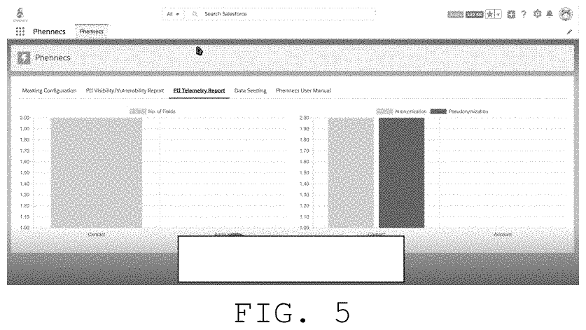

To understand the scope of the anonymized/pseudonymized data or the progress of a particular obfuscation process, embodiments of the DOT provide a Telemetry Report that includes information such as, for example, the number of fields that have been obfuscated and the type of obfuscation used. FIG. 5 shows a screenshot from an exemplary DOT application where a user has generated a very simple Telemetry Report with two bar charts. The chart on the left indicates that a total of two fields in the Contact object have been obfuscated. The chart on the right indicates that the fields have been both anonymized and pseudonymized. It is understood that these Telemetry Reports can be customized in many different ways to display various other kinds of information related to completion and progress of the obfuscation processes.

Data Seeding

In some cases, a user may want to populate an empty sandbox with dummy data for development or testing. For example, there are two types of Salesforce sandboxes that do not have data in them (Developer SB and Developer Pro). These sandboxes copy an instance with all of its associated functionality but with no data. Embodiments of the DOT enable these empty sandboxes to be populated with data using a seeding process. The DOT application allows the user to seed the sandbox with dummy data (data having no relation to the production data) or with a combination of dummy data, obfuscated data, and/or original data. This provides the developer with a customizable synthetic data seeding feature wherein sensitive data is obfuscated (or not used at all) and other data that is not considered sensitive can be simply copied from the production environment. In one embodiment, DOT transforms real data into nonsensitive data and then uses this new set of data as a seed for additional environments. This process may be referred to as nonsensitive organic data seeding.

Additional Features

Embodiments of the DOT can parse a subset of records for transformation and processing based on user-prescribed criteria.

Embodiments of the DOT can transform data off-platform.

Embodiments of the DOT can schedule a time to process prior to running a data transformation.

Embodiments of the DOT provide search capability within the transformation configuration.

On some platforms, when a record is being updated or created, a lock is placed on that record to prevent another operation from updating the record at the same time and causing inconsistencies. Embodiments of the DOT allow for serial processing to avoid this problem. Serial processing can be activated manually or automatically either prior to processing or during processing on a retry in response to an error.

Embodiments of the DOT can be called by external services (e.g., a security command center and/or COEs.

Embodiments of the DOT can allow for configurations to be built at the Call Level Interface and/or call executions from code.

In some cases, the DOT may be implemented as a managed package. Typically, one managed package cannot change the parameters (e.g., triggers, validation rules, etc.) of another managed package (e.g., setup, install, etc.). However, in cases where the platform allows for it, embodiments of the DOT can change the parameters of other managed packages prior to or during a data transformation process.

Embodiments of the DOT can sense and process any changes in the active environment and apply necessary obfuscations to new data.

Embodiments of the DOT can be run as a post-refresh update.

Embodiments of the DOT can provide reports and/or alerts to administrative or other users, notifying the user of completion of the transformation and any errors generated during the process.

Embodiments of the DOT can apply restrictions that prevent users from accessing all or portions or environments where a transformation is in process.

Embodiments of the DOT can recognize null fields and prevent the process from replacing the null field with an anonymized/pseudonymized value.

Exemplary DOT Application

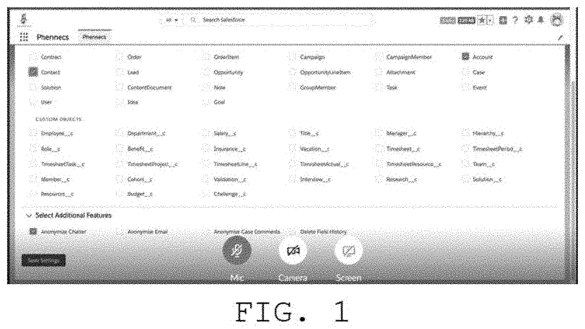

FIGS. 1-3 illustrate a series of exemplary screenshots from an embodiment of an DOT application. In FIG. 1, the user is presented with lists of objects (tables) containing the various fields within the database. Here, the user has selected the Contact object and the Account object for configuration.

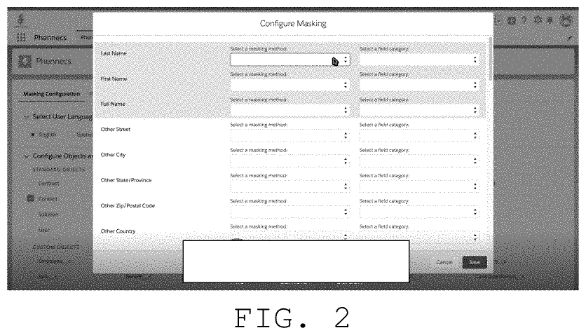

In FIG. 2, the user is provided with basic options for configuring the obfuscation. The user is prompted to select which of the with various fields (in this example, from the Contact and Account objects) will be obfuscated. Here, the first three fields in the list have been arranged at the top of the list and have been displayed in a different color to identify those fields as having a high probability of containing sensitive information. The user has the option to select those highlighted fields and any other fields for obfuscation. The user then selects from a pick list the appropriate obfuscation type for that particular field, e.g., anonymization, pseudonymization, or a hybrid, as discussed herein. The user then selects from a pick list to associate the obfuscated data with a particular field category to associate the obfuscated data with a particular data type to ensure that the output obfuscated data shares those common semantic characteristics with the original input data.

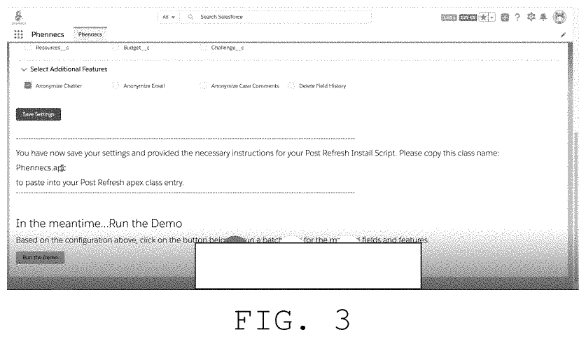

Once the fields are selected and the type of obfuscation is specified, the user saves the information and the configuration window closes. In FIG. 3 the user is notified that the obfuscation configuration settings have been saved, and the DOT has generated a class that is now ready to be run. In this example, the DOT is running on the Salesforce platform, so an apex class has been created, and the user is prompted to cut and paste the class name (here, “Phennecs.apc”) into a Post Refresh apex class entry. In other embodiments, it is possible to run the class on an ad hoc basis.

Other optional features are also shown at the top of the screenshot in FIG. 3 above the Save button. Some of these exemplary features are specific to the Salesforce platform, such as the Anonymize Chatter, Anonymize Email, Anonymize Case Comments, and Delete Field History features. Embodiments of the DOT can manually or automatically make changes to the administrative settings or disable various features of the database platform that can cause issues during obfuscation. For example, the DOT can be configured to automatically disable field history tracking before running the obfuscation. Embodiments of the DOT can also provided feedback to the user about changes that will improve obfuscation, such as, for example, notifying a user that it added a validation rule at some point and warning that data existing before the validation rule may generate errors. Such feedback allows the user to address any issues before obfuscating. It is understood that many different types of feedback will be useful to the user in optimizing the DOT application.

It is understood that embodiments presented herein are meant to be exemplary. Embodiments of the present disclosure can comprise any different combination of compatible features described herein, and these embodiments should not be limited to those expressly discussed.

Although the present disclosure has been described in detail with reference to certain configurations thereof, other versions are possible. Therefore, the spirit and scope of the disclosure should not be limited to the versions described herein.

We claim:

1. A method of obfuscating data, comprising:
receiving a data set that comprises at least one record, each of said records within the data set having a unique identifier;
pre-processing the data set, wherein the pre-processing comprises:
mapping the data set to ascertain the location of all the records within the data set;
sorting the records according to the unique identifier of each record; and
parsing the sorted data set into at least one batch;
designating fields within the data set for transformation;
transforming the data set such that each value in the designated fields are transformed from an original value to a transformed value, wherein the transformed values are disassociated from the original values; and
providing a transformed data set.

2. The method of claim 1, wherein the transforming is done on a single platform without external call-outs.

3. The method of claim 1, wherein the transformed values are anonymized.

4. The method of claim 1, wherein the transformed values are pseudonymized.

5. The method of claim 1, wherein at least some of the transformed values are anonymized and at least some of the transformed values are pseudonymized.

6. The method of claim 1, wherein at least one of the designated fields contain personally identifying information.

7. The method of claim 1, wherein at least some of the transformed values are composite values, each of the composite values comprising a transformed component and an untransformed component.

8. The method of claim 1, further comprising:
prior to transforming the data, determining fields within the data set that are likely to contain personally identifying information.

9. The method of claim 1, wherein the transformation of the designated fields is irreversible.

10. A method of obfuscating data, comprising:
receiving a data set that comprises at least one record, each of said records within the data set having a unique identifier;
pre-processing the data set such that the data set is organized in at least one batch;
designating fields within the data set for transformation;
transforming the data set such that values in the designated fields are transformed from original values to transformed values, wherein the transformed values are disassociated from the original values, and wherein the transformation is performed on a single platform without calling out to any external systems;
providing a transformed data set.

11. The method of claim 10, said pre-processing comprising:
mapping the data set to ascertain the location of all the records within the data set;
sorting the records according to the unique identifier of each record; and
parsing the sorted data set into at least one batch.

12. The method of claim 10, wherein the transformed values are anonymized.

13. The method of claim 10, wherein the transformed values are pseudonymized.

14. The method of claim 10, wherein at least some of the transformed values are anonymized and at least some of the transformed values are pseudonymized.

15. The method of claim 10, wherein at least one of the designated fields contain personally identifying information.

16. The method of claim 10, wherein at least some of the transformed values are composite values, each of the composite values comprising a transformed component and an untransformed component.

17. The method of claim 10, further comprising:
prior to transforming the data, determining fields within the data set that are likely to contain personally identifying information.

18. The method of claim 10, wherein the transformation of the designated fields is irreversible.

19. A method of obfuscating data, comprising:
receiving a data set that comprises at least one record, each of said records within the data set having a unique identifier;
pre-processing the data set such that the data set is organized in at least one batch;
determining a subset of fields within said data set that are likely to contain personally identifying information base on at least one criterion;
designating the subset of fields for transformation;
transforming the data set such that values in the designated subset of fields are transformed from original values to transformed values, wherein the transformed values are disassociated from the original values;
providing a transformed data set.

20. The method of claim 19, wherein the transformation is performed on a single platform without calling out to any external systems.
